(19) United States
(12) Patent Application Publication
(10) Pub. No.: US 2004/0176509 A1
(43) Pub. Date: Sep. 9, 2004

(54) Method of producing a light guide body

(76) Inventor: Lin Ming Hsien, Kaohsiung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/382,750

(22) Filed: Mar. 4, 2003

(51) Int. Cl. C08J 3/00

(52) U.S. Cl. 524/398; 524/394

(57) ABSTRACT

A process for producing a light guide body is disclosed. A polymer composition is prepared from a polymer and a solidifying agent. The solidifying agent has an operative temperature at which the solidifying agent is, operative to solidify the polymer, wherein the operative temperature is higher than or equal to the T_{g} of the polymer. The polymer composition is heated to melt at a temperature higher than T_{g}. The molten liquid of the polymer is molded and cooled so as to solidify at the operative temperature of the solidifying agent. Preferably, the molten liquid is cooled rapidly to a supercooled liquid state during the molding step. Due to the high expansion coefficient of the supercooled liquid of the polymer, there are changes in thickness and density in part of a molding from the molten liquid. The process produces a light guide body having concave or convex surfaces without using an expensive patterned mold.

### BACKGROUND OF THE INVENTION

1. Field of the Invention

This invention relates to a method of producing a light guide body from a polymeric material.

2. Description of the Related Art

A light guide panel includes a light incident face at one side thereof to permit light emitted from a light source to be introduced into the light guide panel, and a light exiting side opposite to the light incident face. When the light from the light source is incident in the light guide panel, it transmits through the light guide plate and emanates from the light exiting side. In case, a light guide panel is used in an illuminating system, it is important that the light can emanate efficiently and uniformly from the light exiting side of the light guide plate. For this purpose, the prior art has suggested to provide protrusions or indentations, or convex and concave surfaces, on the light exiting side of a light guide plate. Generally, these convex and concave surfaces are formed by providing a particular pattern in a mold which is used to form the light guide plate from a polymer. Since the production of such a mold is costly, the conventional processes for manufacturing light guide panels are relatively expensive.

### SUMMARY OF THE PRESENT INVENTION

An object of the present invention is to provide a process for producing a light guide body at a low cost, in which the light guide body can be formed with protrusions or indentations by using a temperature controlling method, thus dispensing with the need for expensive patterned molds.

According to the phase change phenomenon of a polymer, after a polymer is cooled rapidly from a heated temperature higher than its melting temperature, it can become a super-cooled liquid. When the polymer is further cooled from the supercooled liquid state to a glass transition temperature (T_{g}) it reaches a glassy state. It is -observed that the expansion coefficients of a polymer at the supercooled liquid state increase several times as compared to that at a temperature lower than the glassy state. The changes in specific volume with temperature for a polymer are illustrated in a diagram of FIG. 1.

In view of these characteristics of a polymer, a temperature controlling method is utilized in the present invention for forming a light guide body from a polymer. Since the volume or thickness of a polymer can be increased when the polymer is solidified at a temperature higher than T_{g}, the invention contemplates controlling the temperature for solidifying the polymer during the process of molding the polymer so as to vary the volume or thickness and the density within some regions or parts of the molded body formed of the polymer. Due to the variations in volume or thickness, protrusions and indentations, or convex or concave surfaces can appear on the surface of the molding.

Accordingly, a process for producing a light guide body in the present invention comprises: preparing a polymer composition having a glass transition temperature; adding at least one solidifying agent to the polymer composition, the solidifying agent having an operative temperature at which the solidifying agent is operative to solidify the polymer composition, the operative temperature being higher than or equal to the glass transition temperature; heating the polymer composition containing the solidifying agent, to a temperature which is higher than the glass transition temperature and which causes the composition to become a molten liquid; and molding and cooling the molten liquid, wherein the molten liquid begins to solidify at the operative temperature of the solidifying agent. Preferably, the molten liquid is cooled rapidly to a supercooled liquid state during the molding of the molten liquid, and the operative temperature of the solidifying agent is higher than the glass transition temperature.

### BRIEF DESCRIPTION OF THE DRAWINGS

Other features and advantages of the present invention will become apparent in the following detailed description of the preferred embodiments with reference to the accompanying drawings, of which:

FIG. 1 is a diagram illustrating the changes in specific volume (Cᵥ) with temperature (T) for a polymer;

FIG. 2 is an elevation view a light guide body produced in Example 1;

FIG. 3 is an elevation view a light guide body produced in Example 2; and

FIG. 4 is an elevation view a light guide body produced in Example 3.

### DETAILED DESCRIPTIONS OF PREFERRED EMBODIMENTS

In the process of the present invention, a polymer composition may be prepared from a single polymer or a mixture of polymers having good optical characteristics. Preferably, the polymer has a refractive index of about 1.3-2.0 and a light-transmission coefficient greater than 80%. Examples of the polymers are polycarbonate, polyacrylates, polystryene, and polyolefins.

The polymer composition may contain one or more solidifying agents. When more than one solidifying agents are used, the operative temperatures thereof are different from each other. The solidifying agents usable in the present invention may be selected from the group consisting of barium stearate, calcium stearate, zinc stearate, cadmium stearate, mercapto-organotin, epoxides and silica gel coprecipitated with lead silicate.

The polymer composition may be formed into a light guide body by using any molding method. Preferably, an extrusion molding is used to form the light guide body. The rate of the extrusion molding is preferably controlled to be about 0.1-10 cm/min.

### EXAMPLE 1

A polymer composition is prepared by using polycarbonate having a refractive index of 1.584 and a light-transmission coefficient of about 92%. Polycarbonate has no crystalline melting temperature. The T_{g} of polycarbonate is 110° C. The expansion coefficient of polycarbonate at the glassy state is (60-100)×10⁻⁶/° C. At 180° C., the supercooled liquid of polycarbonate has an expansion coefficient of 1.3×10²/° C.

The polymer composition in this example contains more than one solidifying agent. The solidifying agents include barium stearate, calcium stearate, zine stearate, and cadmium stearate which respectively have the following operative temperatures: 180-200° C.; 145-160° C.; 120-125° C.; and 102-112° C.

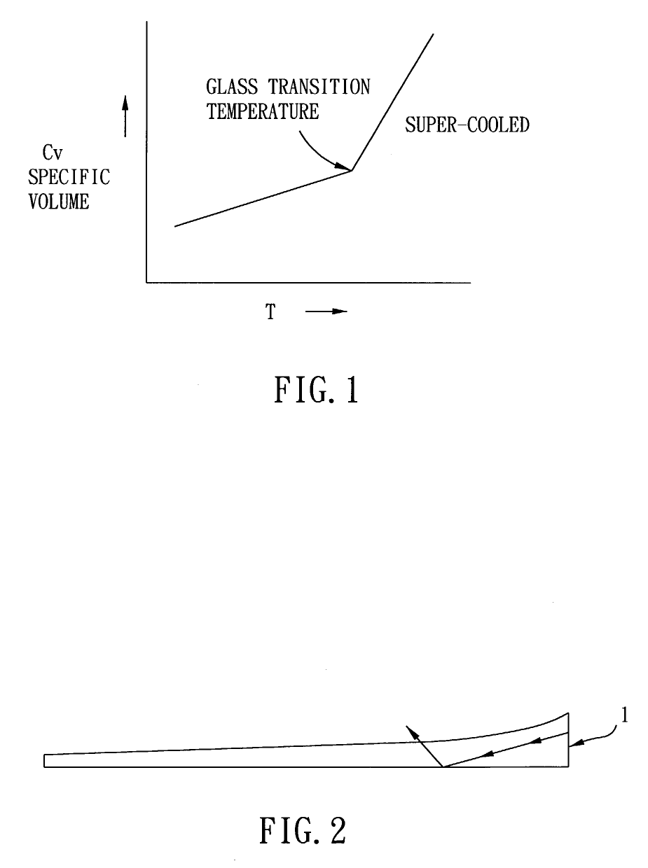

The polymer composition is first heated to a molten state having a temperature higher than 200° C., and is then formed by extrusion molding. The rate of the extrusion molding is controlled at 0.1-1 cm/min, and the extruded body pressure is 100 lb/inch². During the extrusion molding, the extruded body is cooled rapidly to a supercooled state. When the temperature of the extruded body is 180-200° C., barium stearate becomes operative so that the extruded body is solidified due to barium stearate. When the temperature is lowered to 145-160° C., calcium stearate is operative, but barium stearate becomes inoperative. In this situation, the extruded body is solidified due to the effect of calcium stearate. When the temperature of the extruded body is further lowered to 120-125° C., zinc stearate becomes operative to solidify the extruded body. When the temperature is 102-112° C., cadmium stearate is operative to solidify the extruded body. After the extruded body is completely solidified, it forms a light guide panel as shown in FIG. 1.

Since the expansion coefficient of polycarbonate is the highest at 180-200° C. and decreases when the temperature is lowered, the light guide panel 1 has a greatest height at one side thereof. The height of the light guide panel 1 decreases gradually toward the other side. The slanting surface of the light guide panel 1 is slightly concave. It is noted that when the thickness of tho extruded body from the extruder is 1 cm, the light guide panel can project with a height of about 0.4 cm at the highest side thereof.

### EXAMPLE 2

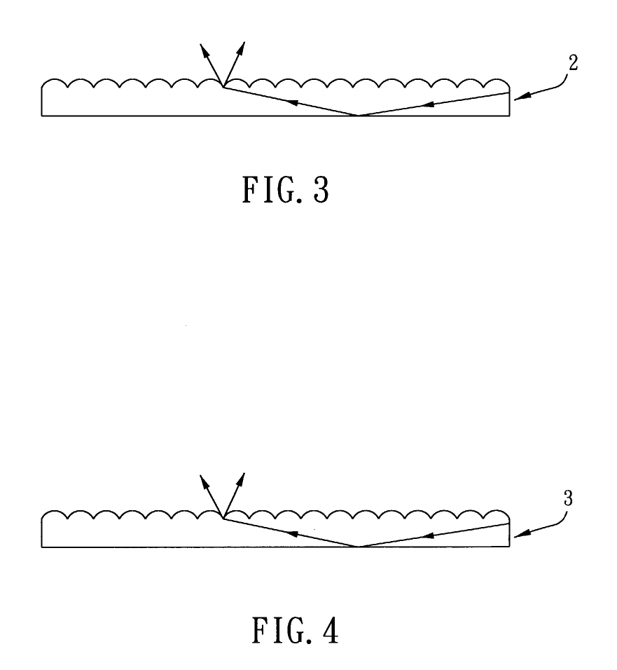

A polymer composition is prepared from polymethyl methacrylate (PMMA) which has no crystalline melting point. The T_{g} of PMMA is 85-105° C. The expansion coefficient at T_{g} is about (50-90)×10⁻⁶/° C. At 150° C., the expansion coefficient of PMMA at the supercooled liquid state is 10⁻²/° C. PMMA is mixed with the solidifying agents, i.e. a mixture of cadmium stearate and zinc stearate. The operative temperature of the solidifying agents ranges from 140° C. to 160° C. An extruder is used in this example to form a light guide panel from the PMMA composition. The rate of the extrusion molding is about 1 cm/min. A temperature control according to the present invention is carried out at one surface of the extruded body of the PMMA composition. A cooling device, such as a water spraying device, is disposed at the exit of the extruder to cool down the surface of the extruded body to 140-160° C. and to further lower the temperature gradually. In this situation, due to thermal contraction, the surface of the extruded body descends gradually. When another cooling device is used to rapidly cool down the extruded body to the glass transition temperature, the extruded body reaches its glassy state. Thereafter, the temperature of the extruded body is caused to increase (e.g. the action of the cooling device on the extruded body is gradually reduced to permit the temperature of the extruded body to increase) for thermal expansion. As a result, the surface of the extruded body ascends. When the surface of the extruded body reaches a certain high, the cooling temperature of the extruded body is reduced once again by controlling the cooling device. By alternately increasing and decreasing the cooling temperature of the extruded body, convex surfaces and indentations are formed on the surface of the extruded body. A light guide panel produced from the extruded body in this example is shown at 2 in FIG. 3. It is noted that, when the height of the extruded body is about 1 cm, the height of the convex surfaces can be about 0.2 cm.

### EXAMPLE 3

A polymer composition is prepared from a mixture of polystyrene (PS) and polycarbonate (PC) in a weight ratio of 1:1. Diisopropyl-peroxy benzene is used as a cross-linking agent. The T_{g} of PS is 105° C. The expansion coefficient of PS at T_{g} is (40-80)×10⁻⁶/° C. The T_{g} of PC is 110° C., and the expansion coefficient thereof at T_{g} is (60-100)×10⁻⁶/° C. After mixing PS and PC, the T_{g} of the mixture 107° C., and the expansion coefficient thereof is (50-90)×10⁻⁶/° C. At 180° C., the supercooled liquid of the mixture has an expansion coefficient of about 1.35×10⁻²/° C. Barium stearate (180-200° C.) is used as a solidifying agent. An extruder is used in this example to form a light guide panel. A temperature control according to the present invention is carried out at one surface of the extruded body of the PMMA composition. When the temperature of the extruded body of the polymer composition is 180-200° C., solidification begins. When the temperature decreases further, barium stearate becomes inoperative. By controlling the temperature of the extruded body, convex surfaces can be formed on the surface thereof. The light guide panel resulting from the extruded body is shown at 3 in FIG. 4. When the height of the extruded body is about 1 cm, the height of the convex surfaces can be about 0.45 cm.

As mentioned above, light guide panels having convex or concave surfaces are formed according to the present invention by controlling the temperature of solidifying the polymer composition. With the present invention, a light guide panel can be produced with convex or concave surfaces without using an expensive mold. In addition, the light guide panel has improved refraction characteristics and can efficiently scatter light at the exiting side thereof. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A process for producing a light guide body comprising:
preparing a polymer composition having a glass transition temperature;
adding at least one solidifying agent to the polymer composition, the solidifying agent having an operative temperature at which the solidifying agent is operative to solidify the polymer composition, the operative temperature being higher than or equal to the glass transition temperature;
heating the polymer composition containing said solidifying agent, to a temperature which is higher than the glass transition temperature and which causes the polymer composition to become a molten liquid; and
molding and cooling said molten liquid, wherein the molten liquid begins to solidify at the operative temperature of the solidifying agent.

2. The process as claimed in claim 1, wherein the molten liquid is cooled rapidly to the glass transition temperature during the molding of the molten liquid.

3. The process as claimed in claim 1, wherein an extruder is used to mold the molten liquid.

4. The process as claimed in claim 3, wherein the molten liquid is extruded at a rate of about 0.1-10 cm/min.

5. The process as claimed in claim 4, wherein a cooling device is disposed at the exit of the extruder to cool down an extruded body from the extruder to the operative temperature of the solidifying agent.

6. The process as claimed in claim 5, wherein the temperature of the extruded body from the extruder is alternately decreased and increased downstream of said cooling device.

7. The process as claimed in claim 1, wherein a plurality of the solidifying agents are added to the polymer composition, and the operative temperatures of the solidifying agents are different from each other.

8. The process as claimed in claim 1, wherein the polymer composition contains at least one polymer.

9. The process as claimed in claim 8, wherein the polymer composition contains more than one polymer.

10. The process as claimed in claim 8, wherein the polymer has a refractive index of about 1.3-2.0 and a light-transmission coefficient greater than 80%.

11. The process as claimed in claim 8, wherein the polymer is selected from a group consisting of polycarbonate, polyacrylates, polystryene, and polyolefins.

12. The process as claimed in claim 1, wherein the operative temperature of the solidifying agent is higher than the glass transition temperature.

13. The process as claimed in claim 1, wherein the solidifying agent is selected from a group consisting of barium stearate, calcium stearate, zinc stearate, cadmium stearate, mercapto-organotin, epoxides and silica gel coprecipitated with lead silicate.
